(19) United States
(12) Patent Application Publication
(10) Pub. No.: US 2014/0308529 A1
(43) Pub. Date: Oct. 16, 2014

(54) Coating Composition And Antireflective Coating Prepared Therefrom

(71) Applicant: SOLVAY SA, Brussels (BE)

(72) Inventors: Ferdinand Hardinghaus, Bad Honnef (DE); Harald Beck, Niederbreitbach (DE); Klaudia Wiedemeyer, Vettelschoss (DE); Jörg Klaus Glas, Rheinbrohl (DE); Karl Köhler, Diekholzen (DE); Marc Lacroix, Louvain-La-Neuve (BE); Daniel Decroupet, Fosses-La-Ville (BE); Francois Lecolley, Trivieres (BE)

(21) Appl. No.: 14/349,680

(22) PCT Filed: Oct. 2, 2012
(86) PCT No.: PCT/EP2012/069399

§ 371 Date: Apr. 4, 2014

(30) Foreign Application Priority Data
Oct. 6, 2011 (EP) 11184162.3

(51) Int. Cl. C09D 5/00; G02B 1/11; G02B 1/12; C09D 7/12

(52) U.S. Cl. CPC C09D 5/006; C09D 7/1266; G02B 1/111; G02B 1/12; C08K 3/16
USPC 428/447; 106/2; 524/853; 427/385.5; 427/553

(57) ABSTRACT

The present invention relates to a coating composition and antireflective coatings prepared therefrom. The invention further relates to a process for the preparation of the antireflective coating on a substrate using the coating composition.

This application claims priority to European patent application No. 11184162.3 filed on 6 Oct. 2011, the whole content of this application being incorporated herein by reference for all purposes.

The present invention relates to a coating composition and antireflective coatings prepared therefrom. The invention further relates to a process for the preparation of the antireflective coating on a substrate using the coating composition.

Antireflective coatings are used for a broad range of technical applications. For instance, antireflective glass plates carrying such coatings are employed for photovoltaic, solarthermal and architectural purposes as well as picture frames. Optical lenses having an antireflective coating are employed in a number of optical devices, such as, for example, cameras, binoculars and eyeglass lenses. Moreover, antireflective coatings play an important role in a number of electrical components, including, for example, displays, light emitting devices and touchscreens.

Accordingly, a number of compositions for the preparation of antireflective coatings are described in the prior art. For example WO 2010/079495 discloses coatings that exhibit both self-cleaning and antireflective properties. Such coatings can be obtained by laminating a substrate with a two component system comprising an antireflective agent and a self-cleaning agent.

EP-A-1 818 694 discloses picture frames with antireflective glass plates. Such picture frames can be used for framing photos and paintings. The glass plates have a light reflection reducing coating wherein the coating contains nanosize particles and a binder. The coating is prepared from a coating composition comprising a solvent and up to 20 wt.-% of solids including the nanoparticles and the binder.

WO 2007/068760 relates to articles coated with a durable, nanostructured film having ultra high hydrophobic properties as well as to a coating process for their manufacture. This film comprises two layers : a nanostructured layer comprising at least one binder and nanoparticles associated with the binder, and a layer of an anti-fouling top coat imparting a low energy surface, which at least partially covers the nanostructured layer. A wide range of binders and a wide range of nanoparticles are disclosed. The coating solution used in the preparation of the nanostructured film may comprise 1-15% of nanoparticles in weight relative to the total weight of the coating solution.

US 2006/0049745 relates to electroluminescent devices capable of extracting light from an electroluminiscent layer thereof at a high efficiency. The electroluminescent device comprises inter alia a low-refractive layer. This layer comprises fine particles in an amount of up to 10% by weight.

Substrates covered with antireflective coatings usually have higher values of the optical transmittance factors in comparison to the corresponding uncoated substrates. This effect can be achieved by applying an antireflective coating with a refractive index which is lower than the refractive index of the substrate. This leads to a gradient of refractive index from that of air to that of the substrate. Indeed, reflection is a function of the difference of the square of the indices. In order to obtain an antireflective coating with a sufficiently low refractive index, materials with a relatively high degree of porosity are employed. Such materials are known in the prior art and typically contain either hollow nanoparticles or porous nanoparticles. Such pores are usually filled with ambient air and represent between 20 vol.-% and 70 vol.-% of the antireflective coating.

However, antireflective coatings particularly if they are intended for an outdoor use, should further have an improved mechanical stability and be resistant against environmental factors such as humidity, bird droppings and UV light. In particular, antireflective coatings with a high degree of porosity within the binder matrix often display a low hardness and only a moderate scratch-resistance so that their outdoor use is significantly limited. Therefore, there is still a demand for sufficiently hard and durable antireflective coatings, which are for example suitable for the outdoor use.

Furthermore, the long term exposure of glass surfaces such as solar panels and building windows in an outside environment usually results in the deposition of what is commonly known as “dirt” on the surface of glass. The dirt may comprise particles of sand, soil, soot, clay, geological mineral particulates and any types of inorganic particles present in the air as well as various organic contaminants. Indeed, glass soiling may also come from organic deposits. There are diverse sources of organic pollution; including windborne dirt, bird and other animal droppings, pollution coming from exhaust gases (organic soot from burning coal or diesel), as well as decomposing organic plant substances from leaves, pollen, etc. When these materials become wet, they may spread over the glass surface. As a result, it may form relatively tenacious traces on the substrate, which will reduce the desired performance of the glass (e.g. transparency).

Over the time, such soiling significantly reduces the optical transparency of the glass substrates. Therefore, these glass substrates can lose their effectiveness when they get dirty. For instance, the soiling of the glass substrate can reduce drastically the energy production of solar panels. That is why there is a clear need for an anti-soiling coating in order to keep solar panels clean in particular in dusty and sandy environments such as desert.

In addition, the processes for the preparation of antireflective coatings often suffer from drawbacks such as high production costs, high costs of raw materials and other limitations of their implementation on an industrial scale. Thus, there is a demand for a simple and cost-efficient process for the preparation of antireflective coatings.

It has now surprisingly been found that the above problems can be solved by incorporating a high amount of nanoparticles into the coating composition. Using such coating composition in the preparation of an antireflective coating results in an antireflective coating having improved surface properties. While it is not intended to be bound to any theory it is believed that the high concentration of nanoparticles in the coating composition results in a different structure of the surface of the obtained coating.

Thus, the present invention relates to a coating composition comprising at least
(a) a binder,
(b) nanoparticles and
(c) a solvent,
   wherein the coating composition comprises ≧20 wt.-% of nanoparticles, based on the total weight of the coating composition.

It has furthermore surprisingly been found that combining certain binders with certain nanoparticles in a certain weight ratio results in coating compositions useful in the preparation of antireflective coatings having improved hardness.

Therefore, the present invention also relates to a coating composition comprising
(a) a silane binder,
(b) indium-tin oxide, barium sulfate, and/or magnesium fluoride nanoparticles, preferably indium-tin oxide and/or magnesium fluoride nanoparticles, and
(c) a solvent,
   wherein the weight ratio of binder to nanoparticles is ≦1:1.

In the present invention, the coating compositions are usually liquid coating compositions. By “liquid coating composition” is intended a coating composition that is able to flow, more particularly that can be applied onto a substrate by any wet coating method.

In a preferred embodiment, the nanoparticles are present into the coating composition of the present invention in an amount higher than 20 wt.-%, especially equal to or higher than 22 wt.-%, more specifically equal to or higher than 24 wt.-%, for instance equal to or higher than 25 wt.-% or even, in some cases, equal to or higher than 30 wt.-%, based on the total weight of the coating composition. The nanoparticles are usually present into the coating composition of the present invention in an amount equal to or lower than 50 wt.-%, particularly equal to or lower than 45 wt.-%, more particularly equal to or lower than 40 wt.-%, for example equal to or lower than 35 wt.-%, based on the total weight of the coating composition. The coating composition of the present invention may generally comprise from 20 wt.-% to 50 wt.-% of nanoparticles, preferably from higher than 20 wt.-% up to 50 wt.-% of nanoparticles, more preferably from 22 wt.-% to 45 wt.-% of nanoparticles, most preferably from 24 wt.-% to 35 wt.-% of nanoparticles, each based on the total weight of the coating composition.

In addition to the nanoparticles, the coating composition of the present invention comprises a binder.

The content of binder in the coating composition has an influence on the mechanical and optical properties of the resulting antireflective coating. If the amount of binder is too high the resulting antireflective coating is likely to have a good mechanical stability but, however, a high refractive index because the pores between the nanoparticles will be filled with binder to a high extent. If the content of binder in the coating composition is too low the resulting antireflective coating is likely to have a low refractive index and low mechanical stability. According to the present invention a preferred antireflective coating with a low refractive index, high mechanical stability and a sufficiently high resistance against environmental factors can be obtained if the weight ratio of nanoparticles to binder is generally of equal to or higher than 1:1, particularly equal to or higher than 2:1, more particularly equal to or higher than 3:1, for example equal to or higher than 5:1. The weight ratio of nanoparticles to binder is usually equal to or lower than 20:1, especially equal to or lower than 15:1, more specifically equal to or lower than 13:1, for instance equal to or lower than 8:1. The weight ratio of nanoparticles to binder may typically be in the range of from 1:1 to 20:1, preferably in the range of from 2:1 to 15:1, more preferably in the range of from 3:1 to 13:1, such as around 6:1.

Moreover, the content of binder in the coating composition may be less than 40 wt.-% based on the total weight of the coating composition, especially equal to or less than 30 wt.-%, more especially equal to or less than 20 wt.-%, most especially equal to or less than 10 wt.-%. The content of binder in the coating composition is in general equal to or higher than 0.1 wt.-% based on the total weight of the coating composition, specifically equal to or higher than 0.3 wt.-%, more specifically equal to or higher than 0.5 wt.-%, most specifically equal to or higher than 1.0 wt.-%. Preferably the coating composition comprises from 0.1 wt.-% to 35 wt.-% of binder, preferably from 0.3 wt.-% to 30 wt.-% of binder, most preferably from 0.5 wt.-% to 20 wt.-% of binder and, even more preferred, from 1.0 wt.-% to 10 wt.-% of binder, each based on the total weight of the coating composition.

The binder used in the coating composition of the invention may be any material used to form a film. The binder is defined as a component that improves the adhesion of the particles to a substrate. Without such binder, adhesion of the nanoparticles to the substrate and satisfactory abrasion and/or scratch resistance properties are not achieved. Preferably, the binder is a compound capable of establishing at least one intermolecular bond or interaction with groups at the surface of the substrate. Different categories of intermolecular bonds or interactions can be established, including, without limitation : covalent bonds and non-covalent intermolecular bonds or interactions, such as hydrogen bond, a van der Waals bond, a hydrophobic interaction, an aromatic CH-π interaction, a cation-π interaction or a charge-charge attractive interaction. Preferably, the binder is a compound capable of establishing at least one covalent bond with a group at the surface of the substrate.

Preferably, the binder is a compound capable of establishing at least one intermolecular bond or interaction with a group at the surface of the nanoparticles. It is also preferred that the binder be a compound capable of establishing at least one covalent bond with a group at the surface of the nanoparticles. Ideally, the binder is a compound capable of establishing covalent bonds with both groups at the surface of the nanoparticles and at the surface of the substrate.

The binder may be an organic material. The binder can be formed from a thermoplastic material. Alternatively, the binder can be formed from a thermosetting material, or a material that is capable of being crosslinked. It is also the scope of this invention to have mixtures of those materials, for example a mixture a thermoplastic binder and a cross-linked binder.

More preferably, the binder is a material which is capable of being cross-linked, for example by polycondensation, polyaddition or hydrolysis. Various condensation curable resins and addition polymerizable resins, for example ethylenically unsaturated coating solutions comprising monomers and/or prepolymers, can be used to form the binders. Specific examples of cross-linkable materials useable include phenolinc resins, bismaleimide resins, vinyl ether resins, aminoplast resins having pendant alpha, beta unsaturated carboxyl groups, urethane resins, polyvinylpryrrolidones, epoxy resins, (meth)acrylate resins, (meth)acrylated isocyanurate resins, ureaformaldehyde resins, isocyanurate resins, (meth)acrylated urethane resins, (meth)acrylated epoxy resins, acrylic emulsions, butadiene emulsions, polyvinyl ester dispersions, styrene/butadiene latexes or mixtures thereof. The term (meth)acrylate includes both acrylates and methacrylates.

Another category of binder materials useful in the present invention comprises silica organosols, for example functional silanes, siloxanes or silicates (alkali metal salts of silicon-oxygen anions) based compounds, or hydrolyzates thereof. Upon hydrolysis, such organofunctional binders generate interepenetrating networks by forming silanol groups, which are capable of bonding with the organic or inorganic surface of the article.

Preferably, the binders are organically modified inorganic binders which include hydrolysable or partially hydrolysable metal compounds. For example polysiloxanes (or silicones, [R₂SiO]ₙ) matrixes, may be prepared from hydrolysable silanes of formula RₘSiX₄₋ₘ in which the group or groups X, which may be identical or different but are preferably identical, are hydrolysable substituents; the group or groups R, which may be identical or different, are hydrolysable or non-hydrolysable substituents, preferably non-hydrolysable substituents; and m may adopt the value 0, 1, 2 or 3, preferably 0, 1 or 2, with particular preference 0 or 1. The substituents X are preferably selected from hydrogen, halogen atoms (especially chlorine and bromine), alkoxy groups, alkyl carbonyl groups and acyloxy groups, particular preference being given to alkoxy groups, especially C₁₋₄ alkoxy groups such as methoxy, ethoxy, propoxy, and butoxy groups as well as their isomers (iso-propoxy, sec-butoxy, or t-butoxy etc.). The groups R may be alkyl, alkenyl, aryl, alkylaryl, arylalkyl or R′Y. R′ is straight-chain or branched alkylene which may be interrupted by oxygen or sulphur atoms or NH groups, or is phenylene, alkylphenylene or alkylenephenylene. Y is a functional group by way of which crosslinking is possible. Examples of Y are unsubstituted or substituted amino, amide, alkyl-carbonyl, unsubstituted or substituted aniline, aldehyde, keto, carboxyl, hydroxyl, alkoxy, alkoxy-carbonyl, mercapto, cyano, hydroxyphenyl, alkyl, carboxylate, sulphonic acid, phosphoric acid, acryloyloxy, methacryloyloxy, methacryloyloxy, glycidyloxy, epoxide, allyl or vinyl groups. Preferably, Y is an acryloyloxy, methacryloyloxy, glycidyloxy, epoxide, hydroxyl or amino group. In the above formulae, substituents R, R′, X and/or Y occurring two or more times may in each case have the same meaning or different meanings in one compound.

Examples of silicon-containing binders are amino-functional silane or amino-functional siloxane compounds such as amino alkoxy silanes, hydroxyl- or lower alkoxy-terminated silanes such as epoxy alkoxy silanes, ureidoalkyl alkoxy silanes, dialkyl dialkoxy silanes (e.g., dimethyl diethoxy silane), (meth)acrylic silanes, coarboxylic silanes, silane-containing polyvinyl alcohol, vinylsilanes, allylsilanes, and mixtures thereof.

Amino alkoxy silanes may be chosen from, without limitation, 3-amino propyl triethoxy silane, 3-amino propyl methyl dimethoxy silane, 3-(2-amino ethyl)-3-amino propyl trimethoxy silane, amino ethyl triethoxysilane, 3-(2-amino ethyl)amino propyl methyl dimethoxy silane, 3-(2-amino ethyl)-3-amino propyl triethoxy silane, 3-amino propyl methyl diethoxysilane, 3-amino propyl trimethoxysilane, and mixtures thereof.

Ureidoalkyl alkoxy silanes may be chosen from, without limitation, ureidomethyl trimethoxysilane, ureidoethyl trimethoxysilane, ureidopropyl trimethoxysilane, ureidomethyl triethoxysilane, ureidoethyl triethoxysilane, ureidopropyl triethoxysilane, and mixtures thereof.

The binder may comprise epoxy alkoxy silane compounds, more preferably alkoxysilanes having a glycidyl group and even more preferably trifunctional alkoxysilanes having a glycidyl group.

Among such compounds, the binder may comprise, for example, glycidoxy methyl trimethoxysilane, glycidoxy methyl triethoxysilane, glycidoxy methyl tripropoxysilane, α-glycidoxy ethyl trimethoxysilane, α-glycidoxy ethyl triethoxysilane, β-glycidoxy ethyl trimethoxysilane, β-glycidoxy ethyl triethoxysilane, β-glycidoxy ethyl tripropoxysilane, α-glycidoxy propyl trimethoxysilane (GPTS), α-glycidoxy propyl triethoxysilane, α-glycidoxy propyl tripropoxysilane, β-glycidoxy propyl trimethoxysilane, β-glycidoxy propyl triethoxysilane, β-glycidoxy propyl tripropoxysilane, γ-glycidoxy propyl trimethoxysilane, γ-glycidoxy propyl triethoxysilane, γ-glycidoxy propyl tripropoxysilane, hydrolyzates thereof, and mixtures thereof.

Other useful alkoxysilanes having a glycidyl group include γ-glycidoxypropyl pentamethyl disiloxane, γ-glycidoxypropyl methyl diisopropenoxy silane, γ-glycidoxypropyl methyl diethoxysilane, γ-glycidoxypropyl dimethyl ethoxysilane, γ-glycidoxypropyl diisopropyl ethoxysilane, γ-glycidoxypropyl bis(trimethylsiloxy)methylsilane, and mixtures thereof.

Other examples of suitable binders are metal alkoxides such as Al, Ti, Zr or Ta alkoxides, preferably Al trialkoxides, Ti tetraalkoxides and Zr tetraalkoxides, methoxides, ethoxides, propoxides and butoxides being particularly preferred.

Further examples of suitable binders are acetylacetonates such as Al, Ti, Zr and Ta acetylacetonates, especially Al, Ti and Zr acetylacetonates.

Examples of particularly suitable binders include silicon tetraethoxide (or ethyl silicate, tetraethoxy silane, tetraethylorthosilicate, TEOS), aluminium triisopropoxide, zirconium tetrabutoxide, titanium tetraisopropoxide, 3-glycidoxy propyl trimethoxysilane (GPTS), and 3-methacryloxy propyl trimethoxysilane (MPTS). MPTS is particularly preferred.

The above mentioned examples of binder materials are a representative showing of binder materials, and not meant to encompass all binder materials. Those skilled in the art may recognize additional binder materials that may fall within the scope of the invention.

It is also possible to use, instead of the above-mentioned organically modified inorganic binders, or in admixture to them, partial hydrolyzates or pre-hydrolyzed compounds thereof. For example, derivatives such as pre-hydrolyzed 3-glycidoxy propyl trimethoxy silane (GPTS) and pre-hydrolyzed 3-methacryloxy propyl trimethoxy silane (MPTS) are especially suitable.

As used herein, the term “nanoparticles” is intended to mean solid particles of which the majority has a size higher than or equal to 1 nm but inferior to 1 μm. Nanoparticles may be spherical or non spherical, elongated, even nanocrystals. The nanoparticles may be bound, adhered to, and/or disperse throughout the binder.

The nanoparticles employed in the the present invention can be spherical, substantially spherical, non-spherical or elongated. Preferably, the nanoparticles used in the present invention are spherical or substantially spherical and have an average aspect ratio of about 1.2 or lower, preferably of about 1.1 or lower.

In the present invention, the particle size of a nanoparticle is defined as its diameter in case of spherical nanoparticles or its smallest dimension if the nanoparticle is substantially spherical, non-spherical or elongated. Processes for determining an average particle size of nanoparticles are known in the state of the art and include, for example, BET absorption, light scattering methods, optical or scanning or transmission electronic microscopy (SEM or TEM) and atomic force microscopy (AFM) imaging.

For instance, the particle size distribution and average particle size of the nanoparticles can be measured with a Coulter Laser difractometer LS230. The solvent used for suspending the nanoparticles is not particularly limited as long as the nanoparticles can be well suspended therein and do not react with the solvent chemically. Preferably, the nanoparticles are ultrasonically dispersed in the solvent for about 10 minutes with an ultrasonic disintegrator. According to the present invention, the average particle size of the employed nanoparticles is generally equal to or lower than 250 nm, often equal to or lower than 150 nm, more often equal to or lower than 100 nm; most often equal to or lower than 60 nm. The average particle size of the employed nanoparticles is usually equal to or higher than 1 nm, in many cases equal to or higher than 3 nm, in most cases equal to or higher than 5 nm, for example equal to or higher than 10 nm. The average particle size of the employed nanoparticles typically ranges from 1 nm to 250 nm, preferably from 3 nm to 150 nm, particularly preferred from 5 nm to 100 nm and even more preferred from 10 nm to 60 nm.

If the average particle size of the nanoparticles is too high, they may show a light scattering effect, which will result in a loss of transmission of the anti-reflective coating. If the employed nanoparticles are too large the optical transmittance factor of the antireflective coating may be affected.

Preferably the employed nanoparticles are non-hollow and substantially free of internal pores. Preferably, the internal pores constitute less than 15 vol.-%, even more preferred less than 10 vol.-%, particularly preferred less than 5 vol.-%, and even more preferred less than 3 vol.-% of the total volume of the nanoparticles.

Nanoparticles suitable for the coating composition of the present invention are typically selected from intrinsically transparent materials, for instance from metallic oxides but not from the corresponding metallic forms which are usually opaque. Said nanoparticles may be organic, inorganic, or a mixture of both. Preferably, inorganic nanoparticles are used, especially metallic or metaloide oxide, nitrade or fluoride nanoparticles, or mixtures thereof.

Examples of suitable inorganic materials include halides of alkaline and alkaline earth metals (such as fluorides, chlorides, bromides or iodides of lithium, sodium, magnesium, calcium, stontium or barium), alkaline earth metal sulfates and carbonates (such as barium sulfate, calcium carbonate, strontium carbonate), metal oxides (such as indium-tin oxide (ITO), titanium dioxide, zirconium dioxide, antimony-tin oxide (ATO), antimony oxide, tin oxide, aluminium oxide, zinc oxide, cerium oxide, tantalum oxide, indium oxide, cerium oxide) and non-metal oxides, like silicon dioxide. Preferably, the inorganic nanoparticles are selected from the group consisting of fluorides of alkaline and alkaline earth metals, alkaline earth metal sulfates and carbonates, and metal oxides. In an especially preferred embodiment, no substantial amount of non-metal oxides, in particular no silicon dioxide, is present in the coating composition of the present invention. Particularly preferred are indium-tin oxide ITO, magnesium fluoride, barium sulfate, calcium carbonate or strontium carbonate, whereby indium-tin oxide ITO and magnesium fluoride are the most preferred materials. In a more particularly preferred embodiment, the inorganic nanoparticles are from indium-tin oxide or a mixture comprising them.

Examples of suitable organic materials include nanoparticles based on polymeric materials, especially on transparent polymeric materials, for instance on nanoparticles of polycarbonate, polymethylmethacrylate, polystyrene or polysulfone.

Preferably, the nanoparticles employed in the coating composition and the antireflective coating of the present invention consist of a single inorganic material. However, coating compositions and antireflective coatings containing nanoparticles of at least two different inorganic materials are also possible. Using different types of nanoparticles allows making hetero-structured coatings.

The choice of a suitable solvent for the coating composition of the present invention mainly depends on the employed binder. Examples of suitable solvents include, for instance, ethanol, isopropanol, n-butanol, ethyleneglycol, propyleneglycol, acetone, toluene, 2-isopropoxyethanol, 2-isopropylamino ethanol and methoxyethanol or mixtures of any of those. 2-Isopropoxyethanol (IPE), 2-isopropylaminoethanol or a mixture thereof are particularly preferred for the preparation of the coating composition. In this regard it is noted that the term “solvent” herein is used to describe a liquid which does not react with the binder and the nanoparticles. It is however not required that the binder and/or nanoparticles dissolve in the solvent. The solvent can rather act as dispersant.

In the coating composition of the present invention, the solvent amount is usually adapted to provide the required viscosity to the resulting coating composition, to allow its application in the form of a coating layer. The solvent amount may thus vary greatly and may for instance be added in an amount from 10 to 500 wt.-% based on the total weight of the coating composition without the solvent, especially from 25 to 200 wt.-%, more particularly from 50 to 100 wt.-%.

In order to avoid re-agglomeration of the nanoparticles in the coating composition, a dispersing agent can be employed. Suitable dispersing agents may be selected from nonionic, cationic, amphoteric, or anionic dispersing agents. Examples of suitable dispersing agents include anionic surface active agents such as a salt of a sulfonic acid, phosphonic acid, carboxylic acid, polycarboxylic acid and the like; cationic surface active agents such as a quaternary salt of a higher aliphatic amine and the like; nonionic surface active agents such as a higher fatty acid polyethylene glycol ester and the like, silicon base surface active agents and high molecular active agents having amide ester bonds. Dispersing agents based on monocarboxylic acid and polycarboxylic acid systems are especially suitable, and their examples include carboxylic acid based surface active agents and sulfonic acid-carboxylic acid systems such as R—COOH, RSO₂NHCH₂COOH, RSCH₂COOH, RSOCH₂COOH, RCH₂COOH, RCH(SO₃H)COOH and the like (R represents a saturated or unsaturated alkyl group having 10 to 20 carbon atoms), polycarboxylic acid system surface active agents having a repeating unit of —CH₂—CH(COOH)—, CH₂CH(CH₂COOH)—CH(Ph)—CH₂—, —CH(COOH)—CH(COOH)—C(CH₃)₂—CH₂—, —CH₂—CH(CH₂COOH)—, and oxa-acids such as 3,6,9-trioxadecanoic acid TODA (CH₃O(CH₂)₂O(CH₂)₂OCH₂COOH), or the like. In the present invention, TODA is particularly preferred. Halogenated surfactants may also be especially advantageous, in particular when the coating composition of the present invention comprises halides of alkaline and alkaline earth metals, for instance, fluorinated surfactants combined with fluorides of alkaline and alkaline earth metals such as MgF₂.

Additionally, the coating composition can contain at least one of further additives, such as UV-dyes, antioxidants, plasticizers, preservatives, colouring agents and lubricants.

In one embodiment of the present invention the coating composition can further contain a catalytic amount of at least one curing catalyst. As suitable curing catalysts for example, photoinitiators (diketones, phenones or quinones) or acidic catalysts (aluminium acetylacetonate or acetic acid) can be employed.

In a further embodiment the present invention provides a coating composition comprising at least:
(a) a silane binder,
(b) indium-tin oxide and/or magnesium fluoride and/or barium sulfate nanoparticles, preferably indium-tin oxide and/or magnesium fluoride, and
(c) a solvent,
   wherein the weight ratio of binder to nanoparticles is ≦1:1, preferably <1:1.

It has indeed surprisingly been found that the combination of a silane binder with indium-tin oxide and/or magnesium fluoride and/or barium sulfate nanoparticles in a certain weight ratio results in antireflective coatings having improved hardness. Indium-tin oxide and/or magnesium fluoride are especially preferred.

In these coating compositions, the weight ratio of nanoparticles to binder preferably is in the range of 1:1 to 20:1, more preferably in the range of 2:1 to 15:1, most preferably in the range of 3:1 to 13:1, such as around 6:1.

The total amount of nanoparticles in the coating composition of this embodiment is less relevant. However, in order to obtain antireflective coatings having an improved surface structure it is preferred that the coating composition comprises at least 20 wt.-% of nanoparticles, preferably more than 20 wt.-% of nanoparticles, more preferably from 22 wt.-% to 40 wt.-% of nanoparticles, most preferably from 25 to 35 wt.-% of nanoparticles, each based on the total weight of the coating composition.

Moreover, it has been found that the hardness of antireflective coatings is particularly high if the silane binder is selected from alkoxysilane compounds, particularly alkoxysilanes having a glycidyl or methacrylyl group, in particular trifunctional alkoxysilanes having a glycidyl or methacrylyl group, such as from 3-glycidoxy propyl trimethoxysilane (GPTS) and 3-methacryloxy propyl trimethoxysilane (MPTS).

Also in this embodiment the coating composition may comprise a dispersing agent as described above, in particular 3,6,9-trioxadecanoic acid (TODA).

With respect to the other components of the coating composition of this embodiment, like the solvent or further additives, reference is made to the above description with respect to the first embodiment of the coating composition of the present invention.

Furthermore, the present invention relates to a process for the preparation of an antireflective coating on a substrate, comprising applying a coating composition as described above to a substrate to form a coating layer on the substrate and drying the coating layer to obtain a dried coating layer or the antireflective coating. The dried coating layer may then optionally be subjected to an additional treatment step such as heat treatment and/or treatment with radiations to lead the antireflective coating.

In this embodiment of the present invention, the coating composition can be applied to the substrate by a number of processes known in the prior art. Such processes include, for example, spin coating, dip coating, slot-die coating, spray coating, flow coating, meniscus coating, capillary coating, roll coating and (electro)-deposition coating. Dip coating is preferred for the preparation of antireflective glass plates coated at both sides and gives a repeatable and constant thickness of the coating. Spin coating is preferably used for the preparation of an antireflective coating on a substrate of a smaller size. Meniscus coating, roll coating or spray coating are particular useful in the case of continuous processes.

The coating composition can be additionally subjected to a microfiltration step before it is applied to the substrate. This allows removal of remaining large agglomerates of the nanoparticles. This step is preferably carried out by passing the coating composition through a filter having an average pore size ranging from 0.1 μm to 20 μm, preferably from 0.2 μm to 10 μm, even more preferred from 0.3 μm to 5 μm and, particularly preferred from 0.4 μm to 1 μm.

It is further preferred that the substrate is thoroughly cleaned before the coating composition is applied to it. Otherwise, small amounts of impurities such as, for example, dust or grease can lead to defects of the antireflective coating and affect its mechanical stability. Cleaning of the substrate can be carried out by using organic solvents, aqueous detergent systems or oxidising agents, depending on the material of the substrate. In the case of heat-resistant substrates this step can be also carried out upon heating up to temperatures ranging from 600° C. to 700° C.

According to the present invention a broad range of transparent materials can be used as substrates, in particular glass, transparent polymeric materials or transparent crystalline inorganic materials, including transparent materials already comprising at least one coating layer such as, for instance, an electric conducting layer. Such transparent materials preferably have an optical transmittance factor of at least 94%, preferably at least 96%, even more preferably at least 98% measured at wavelengths ranging from 425 nm to 675 nm. The haze value of the employed material is preferably lower than 0.8, even more preferably lower than 0.5. The measurements of the corresponding values can be carried out according to the standard ASTM D 1003.

Suitable transparent polymeric materials include polymers such as polycarbonates and thermoplastic polyurethanes or thermosetting (cross-linked) materials such as diethylene glycol bis(allylcarbonate) polymers and copolymers, thermosetting polyurethanes, polythiourethanes, polyepoxides, polyepisulfides, polyesters, poly(meth)acrylates and copolymers based substrates, such as substrates comprising (meth)acrylic polymers and copolymers derived from bisphenol-A, polythio(meth)acrylates, as well as copolymers thereof and blends thereof. In one embodiment of the present invention polymethylmethacrylate is the preferred transparent polymeric material for use as substrate.

Transparent crystalline inorganic materials, which can also be used as substrates include inter alia quartz, potassium bromide, sodium chloride and calcium fluoride.

Glass, however, is the most preferred substrate material.

If the coating composition is prepared in the presence of water or a water-containing solvent the binder can undergo an at least partial hydrolysis. In this case, the resulting oxide layer can form an inorganic transparent coating on the nanoparticles. Such coating on the nanoparticles can lead to stronger interactions between the binder and the nanoparticles and therefore improve the mechanical properties of the resulting antireflective coating.

The water content in the applied solvent can be determined by Karl-Fischer titration.

When the binder is a metal alkoxide, and the dispersion medium is an alcohol, an acid in an amount of up to 1 wt.-%, or water in an amount of up to 20 wt.-% relative to the applied metal alkoxide can be added to accelerate hydrolysis of the alkoxide as required. Pre-hydrolysing of the binder can be, however, omitted, in particular if ITO is employed as nanoparticles.

The viscosity of the coating composition has some influence on the thickness of the obtained antireflective coating and on its surface roughness. Preferably, the viscosity of the coating composition ranges from 2.0 mPa·s to 20.0 mPa·s, measured at a temperature of 25° C. The measurement of dynamic viscosity is carried out according to DIN 53018 with an instrument such as e.g. rotation viscosimeter UM PHYSICA, supplied by Rheolab MC20 Physica. The viscosity is calculated using commercial software RS120.

After application of the coating composition as described above to the substrate, the resulting coating layer is usually dried to eliminate the solvent. Drying may be performed under air or under protective atmosphere such as nitrogen or argon. Drying is typically conducted under atmospheric pressure or under reduced pressure, particularly under atmospheric pressure. Drying is usually conducted at a temperature sufficiently high to allow evaporation of the solvent. Preferably, drying is conducted at a temperature below the boiling point of the solvent to avoid rapid evaporation and formation of bubbles into the coating layer. Such bubbles could indeed increase the coating haze. Drying may for instance be performed at a temperature between 70 and 120° C. when the solvent is 2-isopropylaminoethanol (IPE).

After drying, the dried coating layer may be optionally subjected to a subsequent treatment such as a heat treatment and/or a treatment with radiations.

In one embodiment of the present invention, said subsequent treatment of the coating may be carried out by means of radiation, preferably ultraviolet radiation in particular with a wavelength ranging from 100 nm to 450 nm, for example 172, 248 or 308 nm. The UV treatment may be a single or a repeated UV treatment, for example around 10 to 100 times. The dose is usually around 1 J/cm² per exposure. The time to deliver the nominal dose is adjusted to avoid overheating of the substrate. The source of UV radiation may be selected from any conventional source, for example low- and high-pressure lamps, lasers or electron beam accelerator. The UV treatment can be performed in an oxygen-containing gas atmosphere, an inert gas atmosphere, e.g. nitrogen, argon, helium, or a reductive atmosphere, e.g. a hydrogen or hydrogen containing mix (e.g. 95% N₂ with 5% H₂) atmosphere. The UV treatment is usually conducted at room temperature. The duration of the antireflective coating subsequent UV treatment can be significantly reduced if a photoinitiator is present in the coating composition.

In another embodiment of the present invention, the subsequent treatment of the antireflective coating is carried out at an elevated temperature. Preferably, the subsequent treatment of the coating is performed at a sufficiently low temperature, so that the substrate remains substantially in its shape and does not undergo a thermal degradation. The temperature is usually in the range from 50 to 650° C., preferably 65 to 360° C., more preferably 75 to 315° C. If the substrate is a polymer, the temperature is preferably maximum 65 to 315° C., depending on the nature of the polymer. If the substrate is glass, the temperature of the heat treatment can be higher, for instance from 250 to 650° C. depending on the glass type and thickness, for instance around 250 to 550° C., but most often around 250° C. Such a heat treatment is generally conducted at the selected temperature during 1 to 120 minutes, especially during 5 to 60 minutes. It is also possible to conduct such a heat treatment at high temperatures such as 600 to 720° C. during 2 to 10 min. Such a heat treatment might for instance be combined with a thermal tempering process used for the manufacture of toughened glass. Heat treatment can be conducted using conventional equipment such as ovens. It is also possible to use infra-red (IR) radiations (0.76 μm-2.5 μm) or Near Infra Red (NIR) radiations (2.5 μm-100 μm) to heat the coating layers. Such a heat treatment may be conducted under air or under an inert atmosphere such as nitrogen or argon.

The present invention therefore also relates to an antireflective coating obtainable by the process as described in the present invention, and to a substrate being at least partially coated with an antireflective coating obtainable by such a process.

The refractive index of the such obtained antireflective coating can be adjusted to the refractive index of the substrate. The refractive index of the antireflective coating can for example, range from 1.20 to 1.90, preferably from 1.23 to 1.70, particularly preferred from 1.30 to 1.65, measured at wavelengths ranging from 425 nm to 675 nm and a temperature of 25° C. The measurement of the refractive index of the antireflective coating can be carried out according to the standard ASTM D542 using an ellipsometer.

The optical transmittance factor of the antireflective coating can be at least 90%, preferably at least 95%, particularly preferred at least 95%, averaged at wavelengths ranging from 425 nm to 675 nm and at an average thickness of the coating corresponding to the ¼ of the wavelength at 520 or 550 nm. The measurement of the optical transmittance factor of the obtained antireflective coating can be carried out upon using the same equipment and the same method as for the uncoated substrate.

The average thickness of the antireflective coating for visible light can range from 50 nm to 2000 nm, preferably from 90 nm to 1500 nm, particularly preferably from 100 nm to 1000 nm and, even better, from 110 nm to 700 nm. Preferably, the average thickness of the antireflective coating is a fraction or a multiple of the averaged wavelength passing through the coating, for instance, for an averaged wavelength of 550 nm, the thickness may be 50 nm (λ/11) or 2200 nm (4λ). Such a reasoning is valid for visible light but also for coatings made on items using other parts of the light spectrum, for instance UV light, such as in dye sensitized solar cells (DSSC), or NIR light, such as in organic photovoltaics (OPV). Measurements of the thickness of the antireflective coating can be carried out by using a DekTak surface profiler, e.g. DekTak-150 or by an optical instrument like Filmetrics F20.

The surface roughness of the antireflective coating of the present invention can be determined by averaging measurements made by atomic force microscopy (AFM) or white light interferometry (WLI). Preferably, the antireflective coating can be characterised by the root mean square (RMS) value ranging from 1 nm to 100 nm, preferably from 2 nm to 50 nm, particularly preferred from 3 nm to 30 nm, in the case of an AFM measurement on a surface of 1 μm×1 μm.

The optical and mechanical properties of the obtained antireflective coating depend on the coating composition according to the present invention and particularly depend on the weight ratio nanoparticles : binder. In particular, this ratio has an influence on the porosity of the antireflective coating and therefore can be used for an adjustment of its refractive index. Consequently, the preferred weight ratio of nanoparticles : binder may vary depending on the substrate employed.

Therefore, the present invention also relates to an antireflective coating obtained from a coating composition of the present invention, and to a substrate being at least partially coated with such an antireflective coating.

Furthermore, it has surprisingly been found that the antireflective coatings of the present invention have anti-soiling properties and more surprisingly the antireflective coatings of the present invention comprising indium-tin oxide (ITO) nanoparticles has antistatic and anti-soiling properties. Anti-static properties are related to the prevention or the inhibition of the buildup of static electricity. In particular, the use of anti-static coating can be interesting in order to produce anti-soiling coatings which are able to repel the deposition of dust on surfaces.

Anti-soiling, and preferably anti-static and anti-soiling, coated substrates are an effective way to keep the glass cleaner over longer period of time. In that framework, indium-tin oxide (ITO)-coated glass for example can be of interest due to their anti-static properties. Furthermore, anti-reflective properties can be needed mainly in the case of solar applications.

The present invention also relates to antireflective coatings obtained from a coating composition as defined above. The present invention also relates to such antireflective coatings having antistatic and/or anti-soiling properties, and more particularly to such antireflective coatings comprising at least indium-tin oxide nanoparticles. Furthermore, the present invention also relates to substrates being at least partially coated with such antireflective coatings, more preferably wherein the substrate is glass.

### DESCRIPTION OF THE FIGURES

FIG. 1 shows a SEM image of one of the obtained antireflective coating containing MgF₂ nanoparticles.

FIG. 2 shows a SEM image of one of the obtained antireflective coating containing ITO nanoparticles.

FIG. 3 shows a SEM picture of one of the obtained antireflective coating containing BaSO₄ nanoparticles.

FIG. 4 shows the loss in light transmission due to soiling (ΔLoss=Initial TL−TL after soiling).

FIG. 5 shows the increase of haze due to soiling (ΔGain=Haze after soiling−initial Haze).

For the evaluation of the mechanical properties of antireflective coatings of the present invention a number of mechanical durability tests can be employed.

### Mechanical Tests

### Tape Test

The tape test classification follows a visual observation after pulling off of a tape from the antireflective coatings. The coating layer is classified as either wholly removed, partially removed or left on the substrate. The tape used can be for instance 3M #610.

### Pencil Test

The pencil test can be used for the evaluation of hardness of an antireflective coating (ASTM D 3363-92a). This test is a traditional test for gauging the hardness and for determination of the scratch resistance of coatings by scratching the surface with a pencil of a known hardness. The pencil is held against the film at a 45° angle and pushed away from the operator with a 6.5 mm stroke.

### Dry Brush Test

In order to evaluate the resistance of the antireflective coatings to scratches, the dry brush test can be used. The samples are brushed on an Erichsen brush tester (Model 494) using a normalized nylon brush (ASTM D 2486—The individual bristle diameter was 0.3 mm and bristles where arranged in groups with a diameter of 4 mm). The total weigh of the brush and the holder is of 454 grams. The test is run for 1000 strokes (whereby one stroke is equal to a full cycle of one back and forth motion of the brush).

### Automatic Wet Rub Test (AWRT)

The AWRT is used to evaluate the resistance of the antireflective coating to delamination.

A flat circular teflon head covered with a wetted cotton cloth is dragged on the coating with a constant, built-in load. The abrasion of the cotton over the coated surface will damage (remove) the coating after a certain number of cycles. The cotton should be kept wet with de-ionised water during the whole test. The speed should be adjusted between 60 and 90 full oscillations (back and forth)/minute.

Subsequently, the sample is investigated under an artificial sky to determine whether transparency loss, discoloration and/or scratches could be seen on the sample. The test is run for 50, 100, 250 and 500 strokes. Additionally, coating thickness can be compared by optical method or by profilometry (see above) between tested and untested zones.

### Soiling Evaluation Trials

For the evaluation of anti-static and anti-soiling properties of the antireflective coatings, samples were washed in an industrial washing machine with a cleaning agent (e.g. RBS 50) and then rinsed with deionized water. After washing, samples were installed in a dust chamber at 45° C. and exposed to a mineral contaminant according to the EN60529 standard.

### Chemical Ageing Tests

During these tests, a possible appearance of 3 types of defects is considered:
punctual needle-like defects;
large defects, spots of corrosion having a diameter of few mm²;
dissolution of coatings.

### Cleveland

This test is used to evaluate the resistance of the antireflective coating to condensation and water streaming at the coating surface. The test consists of subjecting the coated substrate to a water-saturated atmosphere at constant temperature. The samples have condensation continually forming on them and this condensation may cause surface degradation.

The test cabinet (Cleveland) is placed in a room with an ambient temperature of (23+/−3)° C. Care needs to be taken to ensure that draughts and solar irradiation do not interfere with the test cabinet. The samples are mounted in a piece holder, which form the roof of the test cabinet. The floor acts as the receptacle for the quantity of water. The test cabinet is conditioned only by heating the demineralised water on the floor with heating resistances controlled by means of a thermocouple, keeping a temperature of the water of (50+/−2)° C.

### Climatic Chamber

This test is used to evaluate the resistance of the antireflective coating to successive water condensation/evaporation processes at the coating surface.

This test is a cycled one and consisted in subjecting the coated glass to the following 2 steps of 1 hour each by rising of temperature from 45 up to 55° C. and inversely, always at 98% rh. The test is identical to the test, which is used to evaluate the resistance of glass to irisation. The employed vessel was a 500 l Weiss chamber.

### Neutral Salt Spray Test

This test is a standard all over the world (duration of 96 hours:IEC 1701, DIN 50021; duration of 500 (optionally 1000) hours:EN1096-2, DIN 50021) whereby the employed plastic cabinet is specially designed to insure the reproducibility of the solicitation.

Test conditions : 35° C.+/−2° C. Salt spray was constituted by distilled water with dissolved NaCl (50 g/l+/−5 g/l) at 25° C.+/−2° C.

According to the above tests the antireflective coatings of the present invention show high hardness, superior mechanical durability and high chemical stability and pass a number of standard DIN and ASTMD coating tests. The hardness of the antireflective coatings of the present invention measured using the pencil test ASTM D 3363-92a can be as high as 6 H.

Antireflective coatings of the present invention can be employed on flat glass such as antireflective glass plates, including glass plates used to made solar cells; as well as in electrical and electronic components such as displays, touchscreens or light emitting devices. Antireflective coatings of the present invention can also be used on articles such as optical devices, for instance cameras, binoculars and eyeglass lenses. It is particularly preferred, however, to use the antireflective coating of the present invention for the manufacturing of antireflective glass plates. Such glass plates are suitable for architectural purposes as well as for use in solar cells.

Due to their high degree of hardness, the antireflective coatings of the present invention are also suitable for a general-purpose use as a coating of diverse polymeric materials, including flat or non-flat polymeric surfaces.

Moreover, antireflective coatings containing specifically ITO or any other electrically conductive nanoparticles can be designed to be electrically conductive. Therefore, such antireflective coatings are highly suitable for use in a variety of electronic components such as displays, touchscreens, light emitting devices, photovoltaic devices, and electrodes for electrophoretic windows, be it as plain electrode (coated on whole surface) or as structured electrodes (for instance printed or etched).

The present invention will be described in detail by the following examples, without, however being limited thereto.

Should the disclosure of any patents, patent applications, and publications which are incorporated herein by reference conflict with the description of the present application to the extent that it may render a term unclear, the present description shall take precedence.

### EXAMPLES

In the following examples, TODA means 3,6,9-trioxadecanoic acid; MPTS means 3-methacryloxy propyl trimethoxysilan; IPE means 2-isopropoxyethanol.

### General Remarks

All samples of antireflective coatings described below were objected to and passed following tests:

### Dry Brush Test

All tested samples showed an excellent performance in this test.

### Automatic Wet Rub Test (AWRT)

No peel off was observed for 500 strokes. Therefore, the test was passed by all tested antireflective coatings.

### Chemical Ageing Tests

No defects were detected for the tested pyrolytic antireflective coatings, in some cases even for test duration up to 21 days. Thus, all tested antireflective coatings passed the test.

### Cleveland

On the basis of appearance and defects analysis of the antireflective coatings after the test could be concluded that all tested samples of the antireflective coatings passed the test.

### Climatic Chamber

On the basis of appearance and defects analysis, all samples of tested antireflective coatings could be considered to have successfully passed the test.

### Neutral Salt Spray Test

All samples of antireflective coatings passed the test successfully.

### Soiling Evaluation Trials

All samples of antireflective coatings presented a low loss in light transmission and low increase of haze.

### Example 1

Powdered magnesium fluoride was thoroughly mixed with the solvent (IPE) and the binder (MPTS) and a dispersing agent (TODA) was added to this mixture upon stirring. The mixture was thoroughly stirred for 10 min at room temperature. Water was added drop wise and the resulting mixture was further stirred and heated to 80° C. for 3 hours. The obtained mixture was filtered by using a microfilter with an average pore size of 0.45 μm.

The resulting coating composition was deposited onto a thoroughly cleaned glass substrate using a spin coater model 1001 CPS II from CONVAC with a spinning speed of 2000 rpm for 15 s. After this, the antireflective coating was dried at 70° C. during 30 min under air and was subsequently treated at an elevated temperature or irradiated by UV-irradiation.

The obtained antireflective coatings were characterised by mechanical tests and by chemical ageing tests.

The properties of the prepared antireflective coatings as well the details of the corresponding coating compositions are summarised in Table 1. In these examples, the layer thickness, refractive index and refractive absorption were measured after the subsequent treatment.

TABLE 1

| sample: | MgF₂ - I | MgF₂ - II | MgF₂ - III | MgF₂ - IV |
|---|---|---|---|---|
| physical | 3.2 | 3.2 | 3.2 | 3.2 |
| density: [g/cm³] | | | | |
| recipe: | 3.38 g MgF₂ | 3.38 g MgF₂ | 3.38 g MgF₂ | 3.38 g MgF₂ |
| | 0.39 g TODA | 0.39 g TODA | 0.39 g TODA | 0.39 g TODA |
| | 0.31 g H₂O | 0.31 g H₂O | 0.31 g H₂O | 0.31 g H₂O |
| | 1.04 g MPTS | 0.52 g MPTS | 0.26 g MPTS | 0.26 g MPTS |
| | 8.012 g IPE | 8.012 g IPE | 8.012 g IPE | 8.012 g IPE |
| subsequent | 1 h, 250° C., | 1 h, 250° C., | 1 h, 250° C., | UV, 3 m/min, 10x |
| treatment | air | air | air | |
| visual | hazefree, | hazefree, | slightly hazy | slightly hazy |
| observations | transparent | transparent | | |
| tape test | No loss | No loss | NO loss, even the | No loss, even the |
| | | | glue sticks on the | glue sticks on the |
| | | | layer | layer |
| Pencil test | 3H | 2H | 2H | H |
| layer thickness | 1075 | 963 | 1061 | 1033 |
| [nm] | | | | |
| refractive | 1.475 | 1.440 | 1.404 | 1.362 |
| index, η | | | | |
| refractive | 0.002 | 0.004 | 0.006 | 0.005 |
| absorption, k | | | | |

The layer thickness, refractive index and refractive absorption were measured again two weeks after the subsequent treatment for sample MgF₂-I and the results were as follows:
Layer thickness (nm): 1003
Refractive index η: 1.468
Refractive absorption k: 0.001

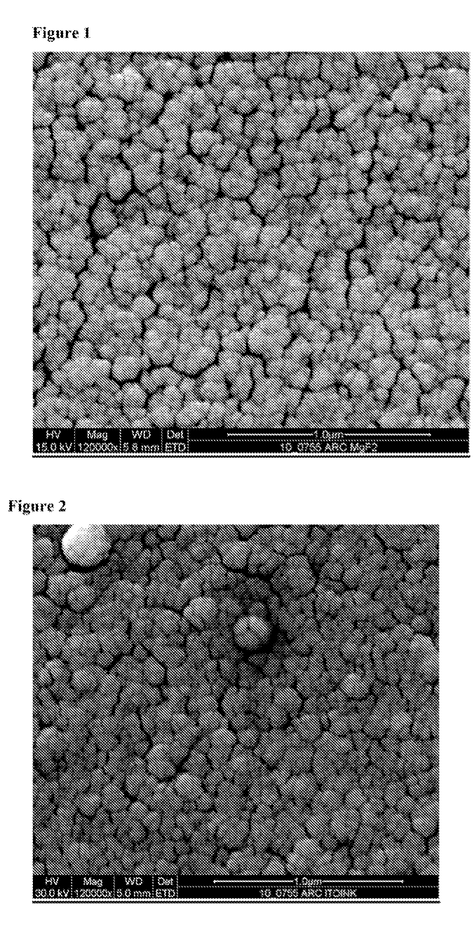

A SEM image of one of the obtained antireflective coating containing MgF₂ nanoparticles is shown in FIG. 1.

### Example 2

Indium tin oxide (ITO) was thoroughly mixed with the solvent (IPE) and the binder (MPTS) and a dispersing agent (TODA) was added to this mixture upon stirring. The mixture was heated to 80° C. for 3 hours.

The antireflective coatings were prepared according to the procedure outlined in Example 1.

The obtained antireflective coatings were characterised by mechanical tests and by chemical ageing tests outlined above. The properties of the prepared antireflective coatings as well the details of the corresponding coating compositions are summarised in Table 2. In these examples, the layer thickness, refractive index and refractive absorption were measured two weeks after the subsequent treatment.

TABLE 2

| sample: | ITO - I | ITO - II | ITO - III |
|---|---|---|---|
| physical | 6.5 | 6.5 | 6.5 |
| density: [g/cm³] | | | |
| recipe: | 6.50 g ITO | 6.50 g ITO | 6.50 g ITO |
| | 0.39 g TODA | 0.39 g TODA | 0.39 g TODA |
| | 1.04 g MPTS | 1.04 g MPTS | 1.04 g MPTS |
| | 8.012 g IPE | 24.262 g IPE | 24.262 g IPE |
| subsequent | 1 h, 250° C., air | 1 h, 250° C., air | UV 3 m/min, |
| treatment | | | 10x |
| visual | hazefree, | hazefree, | hazefree, |
| observations | transparent | transparent | transparent |
| tape test | no loss | no loss | no loss |
| pencil test | 3H | 3H | 2H |
| layer thickness | — | — | — |
| [nm] | | | |
| refractive | 1.619 | — | — |
| index, η | | | |
| refractive | 0.007 | — | — |
| absorption, k | | | |

A SEM image of one of the obtained antireflective coating containing ITO nanoparticles is shown in FIG. 2.

### Example 3

Powdered silicon dioxide (Wacker HDK® N20), calcium carbonate (Socal® 31), barium sulfate or strontium carbonate were thoroughly mixed with the solvent (IPE) and the binder (MPTS) and a dispersing agent (TODA) was added to this mixture upon stirring. The mixture was thoroughly stirred for 10 min at room temperature. Water was added drop wise and the resulting mixture was further stirred and heated to 80° C. for 3 hours. The obtained mixture was filtered by using a microfilter with an average pore size of 0.45 μm.

The antireflective coatings were prepared according to the procedure outlined in Example 1.

The obtained antireflective coatings were characterised by mechanical tests and by chemical ageing tests outlined above. The properties of the prepared antireflective coatings as well the details of the corresponding coating compositions are summarised in Table 3. In these examples, the layer thickness, refractive index and refractive absorption were measured two weeks after the subsequent treatment.

TABLE 3

| sample: | SiO₂ | CaCO₃ | BaSO₄ | SrCO₃ |
|---|---|---|---|---|
| physical | 2.2 | 2.7 | 4.3 | 3.7 |
| density: [g/cm³] | | | | |
| recipe: | 0.75 g SiO₂ | 2.9 g CaCO₃ | 4.6 g BaSO₄ | 3.9 g SrCO₃ |
| | 0.12 g TODA | 0.39 g TODA | 0.39 g TODA | 0.39 g TODA |
| | 0.10 g H₂O | 0.31 g H₂O | 0.31 g H₂O | 0.31 g H₂O |
| | 0.33 g MPTS | 1.04 g MPTS | 1.04 g MPTS | 1.04 g MPTS |
| | 15.0 g IPE | 8.012 g IPE | 8.012 g IPE | 8.012 g IPE |
| subsequent | 1 h, 250° C., | 1 h, 250° C., | 1 h, 250° C., | 1 h, 250° C., |
| treatment | air | air | air | air |
| visual | slightly hazy | hazy | hazefree, | milky |
| observations | | | transparent | |
| tape test | loss, the | slight loss | no loss | loss, the |
| | layer sticks | | | layer sticks |
| | on the tape | | | on the tape |
| pencil test | 4B | 3B | B | 2B |
| layer thickness: | 1246 | 901 | 887 | 884 |
| [nm] | | | | |
| refractive | 1.414 | 1.496 | 1.525 | 1.478 |
| index, η: | | | | |
| refractive | 0.004 | 0.002 | 0.001 | 0.005 |
| absorption, k: | | | | |

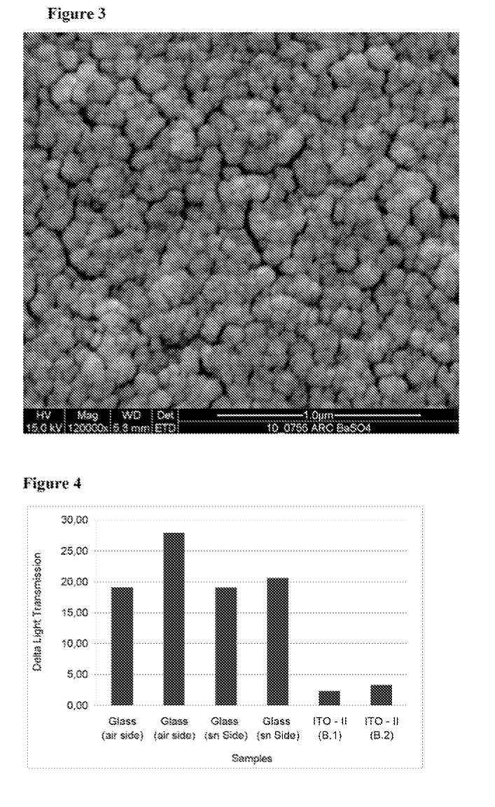

A SEM picture of one of the obtained antireflective coating containing BaSO₄ nanoparticles is shown in FIG. 3.

### Example 4

Coating composition MgF₂-II prepared in Example 1 and coating composition ITO-II prepared in Example 2 were used for the preparation of additional samples of antireflective coatings.

The coating compositions were deposited onto a thoroughly cleaned glass substrate using a spin coater model 1001 CPS II from CONVAC with a spinning speed of respectively 6000 rpm for the MgF₂ coating composition and 2000 rpm for the ITO coating composition. After this, the antireflective coatings were dried during 5 min at 70° C. and were then optionally treated by heat or irradiated by UV-irradiation. Subsequently, optical properties of the coatings as well as the sheet-resistance of the ITO coatings were determined.

The collected data are summarised in Table 4 and Table 5.

TABLE 4

| sample: | MgF₂ - II (A) | MgF₂ - II (B) | MgF₂ - II (C) |
|---|---|---|---|
| physical density: | 3.2 | 3.2 | 3.2 |
| [g/cm³] | | | |
| subsequent treatment | — | UV, 20x | 250° C., 1 h |
| visual observations | hazefree, | hazefree, | hazefree, |
| | transparent | transparent | transparent |
| layer thickness [nm] | 635 | 572.5 | 560 |
| transmission at | 92.4 | 90.6 | 91.3 |
| 550 nm [%] | | | |
| transmission | 93.9 | 95.1 | 95.1 |
| max. [%] | | | |

TABLE 5

| sample: | ITO - II (A) | ITO - II (B) |
|---|---|---|
| physical density: | 6.5 | 6.5 |
| [g/cm³] | | |
| subsequent treatment | — | UV, 20x |
| visual observations | — | hazefree, transparent |
| layer thickness: [nm] | 355 | 284 |
| transmission at | 86.9 | 90.4 |
| 550 nm [%] | | |
| transmission: | 89.7 | 94.2 |
| max. [%] | | |
| sheet-resistance: | — | 8.84 |
| [kOhm/sq] | | |

### Example 5

Anti-static and anti-dust properties of two coating samples comprising ITO nanoparticles, obtained according to example 4 (ITO-II (B.1) and (B.2)), were tested.

For the evaluation of anti-static and anti-dust properties of the coatings comprising ITO nanoparticles, samples were washed in an industrial washing machine with a cleaning agent (e.g. RBS 50) and then rinsed with deionized water. After washing, samples were installed in a dust chamber at 45° C. and exposed to a mineral contaminant according to the EN60529 standard.

For these trials, the mineral contaminant used in the chamber was talc (particle size of maximum diameter 75 μm) and the talc density used for these tests was 2 kg/m³. Samples were exposed in these conditions for 15 minutes.

At the end of the test, samples were stacked in vertical position in order to remove the excess of pollutant not adhering to the surface. Next, light transmission and haze measurement were performed on the soiled samples.

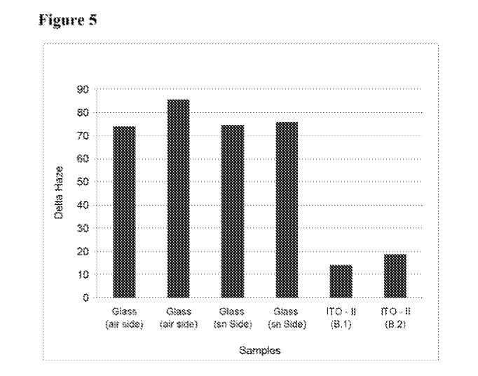

The loss in light transmission due to the soiling (ΔLoss=Initial TL−TL after soiling) is illustrated in FIG. 4. The increase of haze (ΔGain=Haze after soiling−initial Haze) is illustrated in FIG. 5.

Both values are related to the amount of talc stuck on the glass.

1. A coating composition comprising a binder, nanoparticles and a solvent, wherein the coating composition comprises ≧20 wt.-% of nanoparticles, based on the total weight of the coating composition.

2. The coating composition according to claim 1, wherein the coating composition comprises from 20 wt.-% to 50 wt.-% of nanoparticles based on the total weight of the coating composition.

3. The coating composition according to claim 1, wherein the weight ratio of nanoparticles to binder is in the range of from 1:1 to 20:1.

4. The coating composition according to claim 1, wherein the coating composition comprises less than 40 wt.-% of binder based on the total weight of the coating composition.

5. The coating composition according to claim 1, wherein the binder is selected from cross-linkable phenolic resins, bismaleimide resins, vinyl ether resins, aminoplast resins having pendant alpha, beta unsaturated carbonyl groups, urethane resins, polyvinylpyrrolidones, epoxy resins, (meth)acrylate resins, (meth)acrylated isocyanurate resins, ureaformaldehyde resins, isocyanurate resins, (meth)acrylated urethane resins, (meth)acrylated epoxy resins, acrylic emulsions, butadiene emulsions, polyvinyl ester dispersions, styrene/butadiene latexes, silanes, siloxanes or silicates or hydrolyzates thereof, and mixtures thereof.

6. The coating composition according to claim 1, wherein the binder is 3-glycidoxy propyl trimethoxysilane or 3-methacryloxy propyl trimethoxysilane or silicon tetraethoxide.

7. The coating composition according to claim 1, wherein the nanoparticles are selected from halides of alkaline and alkaline earth metals, alkaline earth metal sulfates, alkaline earth metal carbonates, metal oxides, non-metal oxides, and mixtures thereof.

8. The coating composition according to claim 1, wherein the nanoparticles are selected from indium-tin oxide, barium sulfate, magnesium fluoride, calcium carbonate, strontium carbonate, and mixtures thereof.

9. The coating composition according to claim 8 wherein the nanoparticles are from indium-tin oxide or a mixture comprising them.

10. The coating composition according to claim 1, further comprising a dispersing agent.

11. A coating composition comprising a silane binder, indium-tin oxide and/or magnesium fluoride and/or barium sulfate nanoparticles and a solvent, wherein the weight ratio of nanoparticles to binder is ≧1:1.

12. The coating composition according to claim 11, wherein the weight ratio of nanoparticles to binder is in the range of 1:1 to 20:1.

13. The coating composition according to claim 11, wherein the coating composition comprises at least 20 wt. -% of nanoparticles based on the total weight of the coating composition.

14. The coating composition according to claim 11, wherein the silane binder is selected from alkoxysilane compounds, alkoxysilanes having a glycidyl or methacrylyl group, trifunctional alkoxysilanes having a glycidyl or methacrylyl group, 3 glycidoxy propyl trimethoxysilane and 3-methacryloxy propyl trimethoxisilane.

15. The coating composition according to claim 11, further comprising a dispersing agent.

16. A process for the preparation of an antireflective coating on a substrate, the process comprising applying a coating composition according to claim 1 to the substrate to form a coating on the substrate, drying the coating, and optionally subsequently treating the coating by heat treatment or by irradiation to obtain the antireflective coating.

17. The process according to claim 16, wherein the subsequent treatment is carried out by means of radiation, ultraviolet radiation, near infrared radiation or infrared radiation.

18. The process according to claim 16, wherein the subsequent treatment is carried out at an elevated temperature.

19. An antireflective coating obtained by the process of claim 16 or obtained from a coating composition comprising a binder, nanoparticles and a solvent, wherein the coating composition comprises ≧20 wt.-% of nanoparticles, based on the total weight of the coating composition.

20. A substrate being at least partially coated with an antireflective coating according to claim 19.

21.-25. (canceled)
